(19) United States
(12) Patent Application Publication
(10) Pub. No.: US 2026/0040138 A1
(43) Pub. Date: Feb. 5, 2026

(54) SIDELINK CONGESTION CONTROL FOR SENSING AND DATA TRANSMISSIONS

(71) Applicant: QUALCOMM Incorporated, San Diego, CA (US)

(72) Inventors: Stelios STEFANATOS, San Diego, CA (US); Kapil GULATI, Belle Mead, NJ (US); Preeti KUMARI, San Diego, CA (US); Junyi LI, Greentown, PA (US); Shuanshuan WU, San Diego, CA (US)

(21) Appl. No.: 18/996,840

(22) PCT Filed: Sep. 21, 2023
(86) PCT No.: PCT/US2023/074769

§ 371 Date: Jan. 17, 2025

(30) Foreign Application Priority Data
Oct. 5, 2022 (GR) 20220100818

(51) Int. Cl. H04W 28/02

(52) U.S. Cl. CPC H04W 28/0289

(57) ABSTRACT

Various aspects of the present disclosure generally relate to wireless communication. In some aspects, a user equipment (UE) may determine a first channel busy ratio (CBR) associated with one or more data transmissions detected over a first period of time. The UE may determine a second CBR associated with one or more sensing transmissions detected over a second period of time that at least partially overlaps with the first period of time. The UE may transmit a communication based at least in part on the first CBR and the second CBR. Numerous other aspects are described.

### CROSS-REFERENCE TO RELATED APPLICATION

This patent application claims priority to Greek Nonprovisional Patent Application No. 20220100818, filed on Oct. 5, 2022, entitled “SIDELINK CONGESTION CONTROL FOR SENSING AND DATA TRANSMISSIONS,” which is hereby expressly incorporated by reference herein.

### FIELD OF THE DISCLOSURE

Aspects of the present disclosure generally relate to wireless communication and to techniques and apparatuses for sidelink congestion control for sensing and data transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include determining a first channel busy ratio (CBR) associated with one or more data transmissions detected over a first period of time. The method may include determining a second CBR associated with one or more sensing transmissions detected over a second period of time that at least partially overlaps with the first period of time. The method may include transmitting a communication based at least in part on the first CBR and the second CBR.

Some aspects described herein relate to a UE for wireless communication. The user equipment may include a memory and one or more processors coupled to the memory. The one or more processors may be configured to determine a first CBR associated with one or more data transmissions detected over a first period of time. The one or more processors may be configured to determine a second CBR associated with one or more sensing transmissions detected over a second period of time that at least partially overlaps with the first period of time. The one or more processors may be configured to transmit a communication based at least in part on the first CBR and the second CBR.

Some aspects described herein relate to a non-transitory computer-readable medium that stores a set of instructions for wireless communication by a UE. The set of instructions, when executed by one or more processors of the UE, may cause the UE to determine a first CBR associated with one or more data transmissions detected over a first period of time. The set of instructions, when executed by one or more processors of the UE, may cause the UE to determine a second CBR associated with one or more sensing transmissions detected over a second period of time that at least partially overlaps with the first period of time. The set of instructions, when executed by one or more processors of the UE, may cause the UE to transmit a communication based at least in part on the first CBR and the second CBR.

Some aspects described herein relate to an apparatus for wireless communication. The apparatus may include means for determining a first CBR associated with one or more data transmissions detected over a first period of time. The apparatus may include means for determining a second CBR associated with one or more sensing transmissions detected over a second period of time that at least partially overlaps with the first period of time. The apparatus may include means for transmitting a communication based at least in part on the first CBR and the second CBR.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of joint communication and radar sensing (JCR) systems, in accordance with the present disclosure.

FIG. 6 is a diagram illustrating an example associated with sidelink congestion control for sensing and data transmissions, in accordance with the present disclosure.

FIG. 7 is a diagram illustrating an example process associated with sidelink congestion control for sensing and data transmissions, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

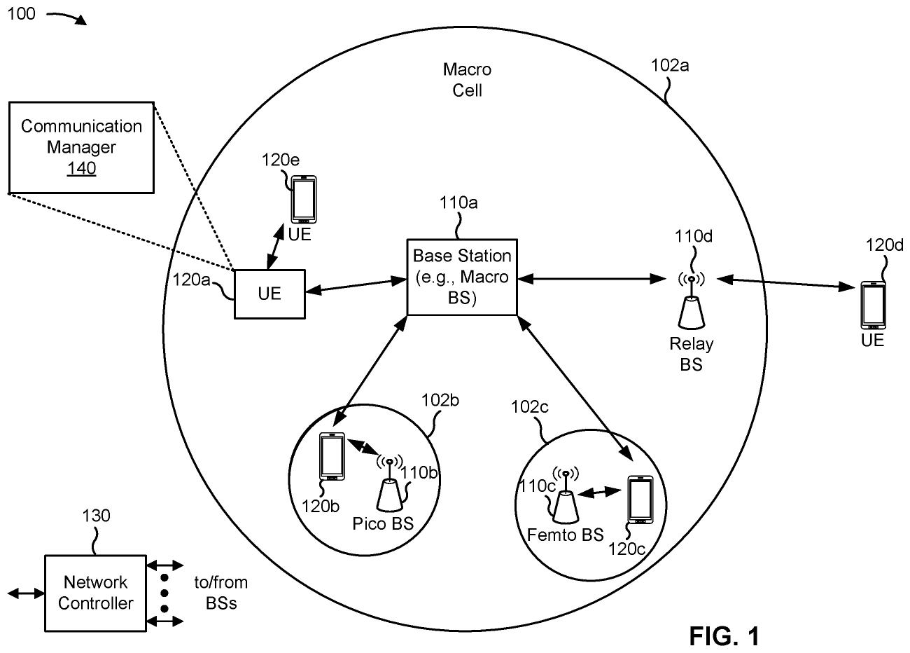

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Deployment of communication systems, such as 5G NR) systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), TRP, or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more central units (CUs), one or more distributed units (DUs), one or more radio units (RUs), or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may determine a first CBR associated with one or more data transmissions detected over a first period of time; determine a second CBR associated with one or more sensing transmissions detected over a second period of time that at least partially overlaps with the first period of time; and transmit a communication based at least in part on the first CBR and the second CBR. Additionally, or alternatively, the communication manager 140 may perform one or more other operations described herein.

As indicated above, FIG. 1 is provided as an example. Other examples may differ from what is described with regard to FIG. 1.

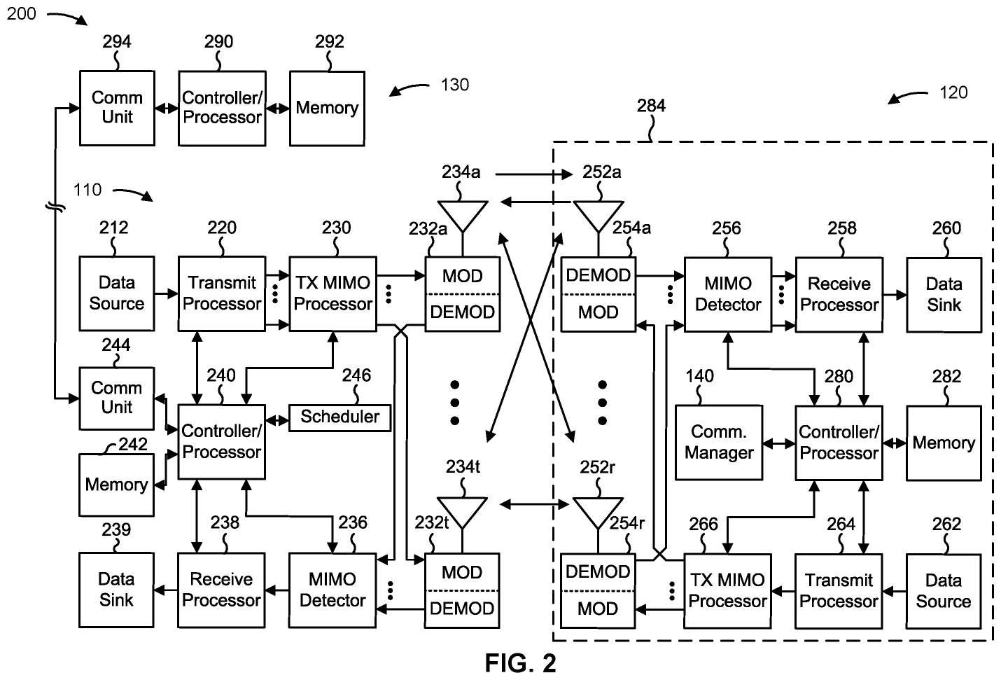

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

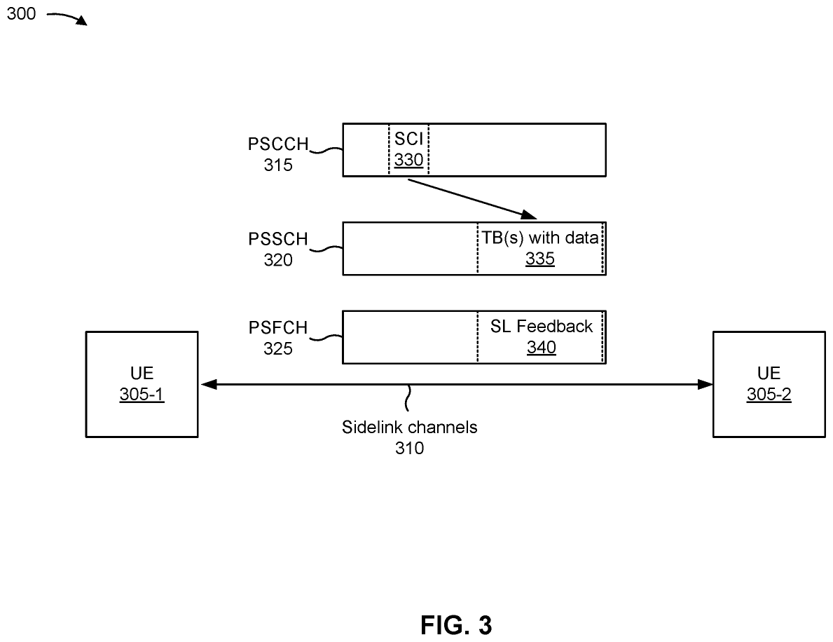

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-8).

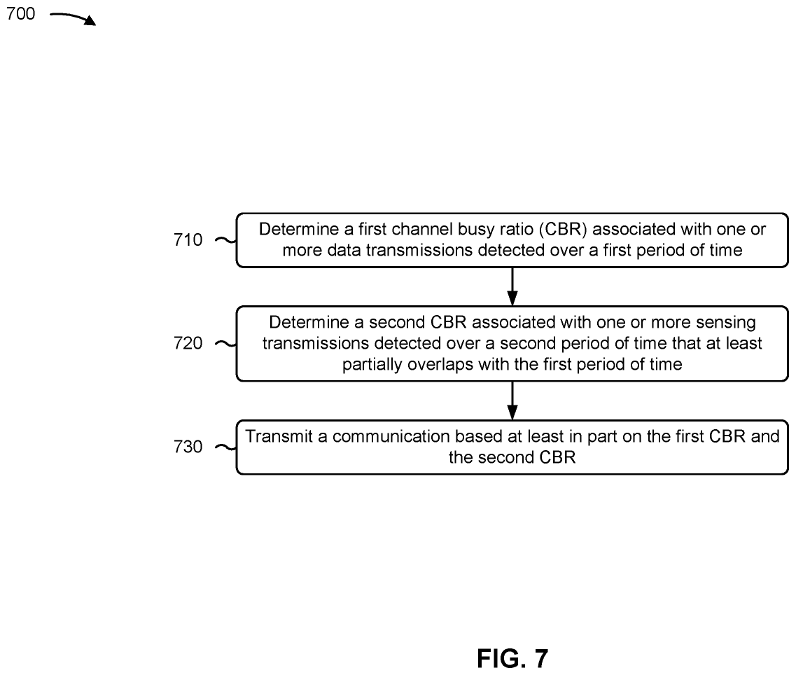

The controller/processor 240 of the base station 110, the controller/processor 280 of the UE 120, and/or any other component(s) of FIG. 2 may perform one or more techniques associated with sidelink congestion control for sensing and data transmissions, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7 and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7 and/or other processes as described herein. In some examples, executing instructions may include running the instructions, converting the instructions, compiling the instructions, and/or interpreting the instructions, among other examples.

In some aspects, the UE includes means for determining a first CBR associated with one or more data transmissions detected over a first period of time; means for determining a second CBR associated with one or more sensing transmissions detected over a second period of time that at least partially overlaps with the first period of time; and/or means for transmitting a communication based at least in part on the first CBR and the second CBR. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in subchannels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE may be configured by higher layers with one or more sidelink resource pools. A sidelink resource pool may be used for transmission and reception of PSCCH/PSSCH and may be associated with sidelink resource allocation Mode 1 or Mode 2. In the frequency domain, a sidelink resource pool may include a number of contiguous subchannels. The size of each subchannel may be fixed and may include N contiguous RBs. Both the number of subchannels and the subchannel size may be higher layer pre-configured (e.g., by radio resource control (RRC)). In some aspects, sidelink may support N=10, 15, 20, 25, 50, 75, and 100 RBs for possible subchannel sizes. In the time domain, the slots available for sidelink may be determined by repeating sidelink bitmaps (e.g., pre-configured). As used herein, a sidelink resource may refer to a single slot-subchannel combination and may include RBs within a single subchannel (in the frequency domain) and over a single slot (in the time domain).

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in an RRC message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a CBR associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

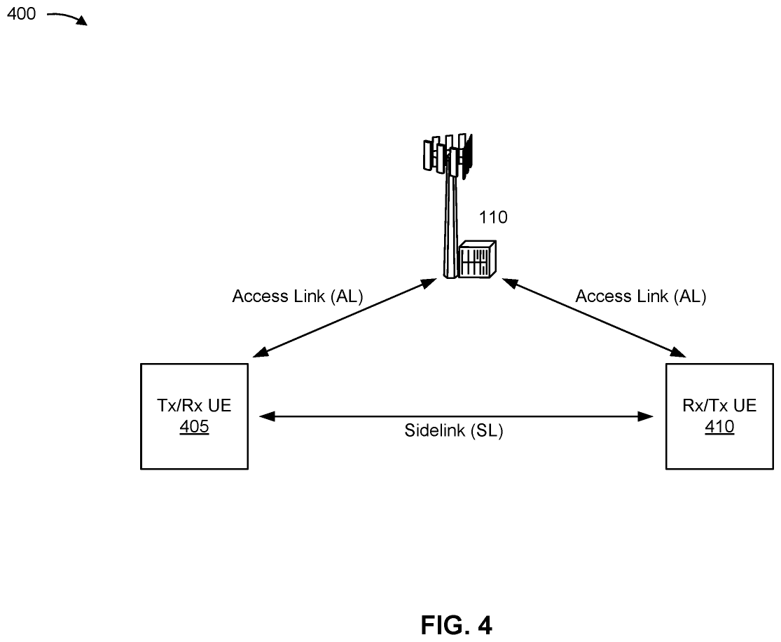

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

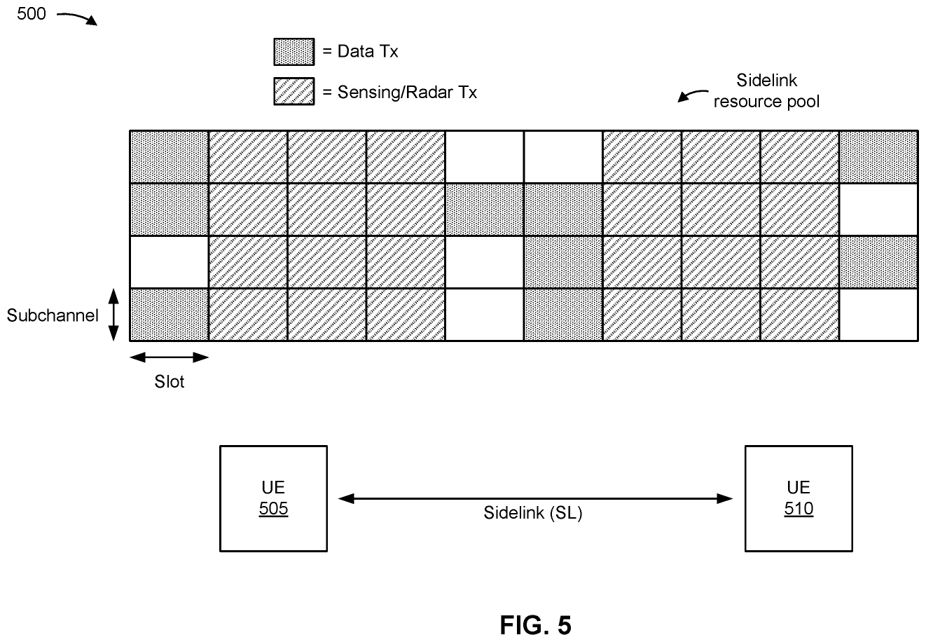

FIG. 5 is a diagram illustrating an example 500 of joint communication and radar sensing (JCR) systems, in accordance with the present disclosure. As shown in FIG. 5, a UE (e.g., UE 505) may communicate with one or more other UEs (e.g., UE 510) via sidelink.

A UE, such as UE 505, may use radio frequency (RF) sensing (e.g., radar sensing) for environmental sensing (e.g., to detect targets). For example, in automotive deployments, a UE associated with a vehicle may transmit one or more sensing transmissions (also referred to as radar transmissions) and measure one or more reflections (e.g., reflections of the sensing transmission off of a target) to determine a distance of a target, a speed of the target, a direction of the target, or an acceleration of the target, among other examples. Reserving dedicated RF resources for radar sensing may result in an inefficient use of RF resources. For example, in cases where few UEs are performing RF sensing, some RF resources may go unused while communication resources are congested with transmissions from many UEs.

Accordingly, some communications systems may integrate wireless communications with RF sensing using a single resource pool for both data and sensing transmissions. In this case, rather than having a first set of resources dedicated for radar sensing and a second set of resources dedicated for communication, a single set of resources is allocated for both communication and radar sensing. For example, some techniques may use a 3GPP (e.g., NR) waveform for both communication and radar sensing, thereby enabling 3GPP devices (e.g., UEs, base stations, roadside units (RSUs), CUs, DUs, RUs, network nodes, or network entities, among other examples) to provide radar sensing using receive processors, such as receive processor 258 of FIG. 2. A configuration in which both communication and radar sensing is enabled for a single set of resources may be termed a “joint communication and radar sensing” or “joint communication and radar” (“JCR”) deployment.

As shown in FIG. 5, a portion of a sidelink resource pool is shown, with data transmissions and sensing transmissions occurring over orthogonal sidelink resources within the sidelink resource pool. As used herein, the transmissions may originate from the same UE (e.g., UE 505), from different UEs, or a combination thereof. As shown, sensing transmissions often have a relatively large bandwidth utilization (e.g., relative to the data transmissions), occupying many or all available subchannels and/or sidelink resources, and often span more than one slot.

As indicated above, FIG. 5 is provided as an example. Other examples may differ from what is described with respect to FIG. 5.

Multiple UEs and vehicles using the same pool of sidelink resources for both data transmissions and sensing transmissions may lead to a significant increase in sidelink network load. In mode 2 sidelink, without a network entity scheduling to ensure orthogonality of transmissions, collisions and interference among transmissions from multiple UEs may be difficult to avoid. Congestion control may facilitate avoiding collisions and interference, using a channel busy ratio (CBR) and channel occupancy ratio (CR). For example, a UE may measure RSSIs of transmissions over a pre-configured sensing window to determine a percentage of resources being utilized by all UEs within range. Using a CR that measures the congestion contributed by the UE itself, the UE may adjust transmission parameters (e.g., MCS, number of subchannels, number of sidelink resources, number of retransmissions, and/or the like) to ensure the CR does not exceed a preconfigured threshold (e.g., a threshold that depends on the measured CBR). While congestion control may enable UEs to avoid some collisions and interference, treating data and sensing transmissions equally may result in overly aggressive data throughput reduction, and treating sensing transmissions as an extra feature or service may de-prioritize sensing transmissions that might be needed for safety features, such as collision avoidance. As a result, a congested resource pool without differentiation of CBR measurement and/or CR calculation for data and sensing transmissions may lead to mis-prioritization of data transmissions and/or sensing transmissions,

Some techniques and apparatuses described herein enable a UE to control congestion in mode 2 sidelink in a manner that differentiates between data transmissions and sensing transmissions. For example, the UE may determine a first CBR associated with data transmissions, a second CBR associated with sensing transmissions, and transmit a communication based at least in part on the first CBR and second CBR. As a result, the UE may use separate CR thresholds for the UE's data transmissions and sensing transmissions, which enables the UE to apply different congestion control between the different types of transmissions when performing congestion control (e.g., transmitting different types of communications with different parameters). In this way, the UE may facilitate the use of a sidelink resource pool in a manner that may improve, relative to congestion control that does not differentiate between transmission types, the UE's ability to reduce collisions and interference among transmissions while also separately prioritizing and managing QoS for data transmissions and/or sensing transmissions. For example, by using different CBR measurements, CR calculations, and/or CR thresholds, the UEs that use a sidelink resource pool may address collisions and interference by prioritizing data and/or sensing transmissions differently.

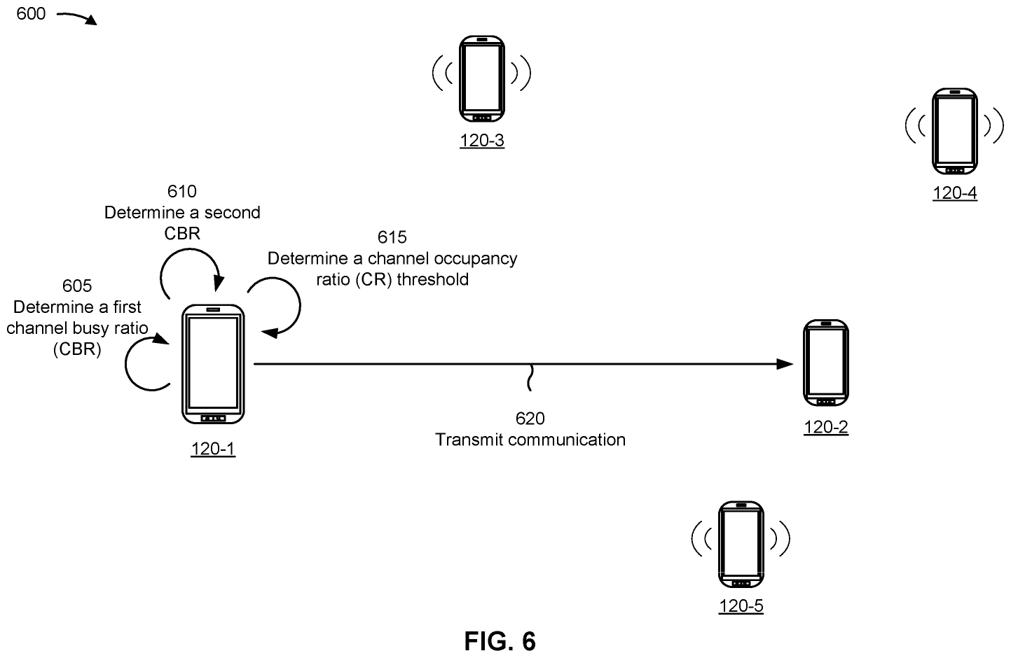

FIG. 6 is a diagram illustrating an example 600 associated with sidelink congestion control for sensing and data transmissions, in accordance with the present disclosure. As shown in FIG. 6, a UE (e.g., UE 120-1) and other UEs (e.g., UE 120-2, UE 120-3, UE 120-4, and UE 120-5) may communicate with one another. For example, the UEs may communicate with one another via sidelink using a shared sidelink resource pool. In some aspects, the UEs may transmit data transmissions and/or sensing transmissions.

As shown by reference number 605, the UE (e.g., UE 120-1) may determine a first CBR associated with data transmissions (e.g., communication transmissions, as opposed to sensing/radar transmissions) detected over a first period of time. In some aspects, the first CBR is based at least in part on a portion of sidelink resources, in a sidelink resource pool, that were used for the data transmissions and a signal strength measurement that satisfies a first signal strength threshold (e.g., a preconfigured RSSI threshold for data transmissions). For example, the first CBR may be measured at a slot n and defined as a portion of sidelink resources in the sidelink resource pool that were used for data transmissions (e.g., sidelink transmissions, such as V2X transmissions) over a CBR measurement window and that have an RSSI, measured by the UE, that satisfies a threshold (e.g., a preconfigured RSSI threshold). The CBR measurement window may be, for example, from n−a to n−1, where a may be a preconfigured period of time (e.g., a may be a number of slots according to a higher layer parameter, such as a timeWindowSize-CBR parameter).

By way of example, in a situation where the first period of time (e.g., the CBR measurement window) includes 1,000 sidelink resources, and 300 were used for data transmissions with RSSI satisfying the first signal strength threshold, the UE may determine that the first CBR is 0.3 (e.g., 300/1,000=0.3).

In some aspects, the UE may identify the data transmissions based at least in part on the data transmissions satisfying a data CBR signal strength threshold (e.g., a preconfigured RSSI threshold), and/or the data transmissions having one or more data-specific characteristics. In some aspects, the data-specific characteristics may include SCI indicating a data transmission, the data transmission having a corresponding slot in which a last symbol of the corresponding slot is empty, and/or the like. For example, if the UE is capable of decoding SCI for a transmission, the UE may determine that the transmission is a data transmission (e.g., the ability to decode alone may indicate a data transmission, and/or an explicit indication in the decoded SCI may indicate a data transmission). As another example, if the last symbol of a sidelink resource is identified as empty (e.g., a gap symbol, or low energy symbol that does not satisfy a preconfigured threshold energy level), this may indicate a data transmission due to the gap symbol being used to facilitate transitioning from a transmission mode to reception mode for the subsequent slot. In some aspects, a transmission may default to being treated as a data transmission simply by satisfying the data CBR signal strength threshold. Any combination of the foregoing criteria for identifying a transmission as a data transmission may be used by the UE.

As shown by reference number 610, the UE may determine a second CBR associated with sensing transmissions (e.g., radar transmissions, as opposed to data/communication transmissions) detected over a second period of time that at least partially overlaps with the first period of time. In some aspects, the second CBR is based at least in part on a portion of sidelink resources, in a sidelink resource pool, that were used for the sensing transmissions and a signal strength measurement that satisfies a second signal strength threshold (e.g., a preconfigured RSSI threshold for sensing transmissions). The UE may measure the second CBR in a manner similar to that of the first CBR, as described herein. For example, the second CBR may be measured at a slot n and defined as a portion of sidelink resources in the sidelink resource pool that were used for sensing transmissions (e.g., radar transmissions) over a CBR measurement window and that have an RSSI, measured by the UE, that satisfies a threshold (e.g., a preconfigured RSSI threshold). The CBR measurement window may be configured to be the same as or different from other CBR measurement windows described herein, and may be configured in a similar way as described herein.

By way of example, in a situation where the second period of time (e.g., the CBR measurement window) includes 1,000 sidelink resources, and 500 were used for sensing transmissions with RSSI satisfying the second signal strength threshold, the UE may determine that the second CBR is 0.5 (e.g., 500/1,000=0.5).

In some aspects, the UE may identify the sensing transmissions based at least in part on the sensing transmissions satisfying a sensing CBR signal strength threshold (e.g., a preconfigured RSSI threshold), and/or the sensing transmissions having one or more sensing-specific characteristics. In some aspects, the sensing-specific characteristics may include SCI indicating a sensing transmission, the sensing transmission includes a preconfigured sequence identifying the sensing transmission, the sensing transmission having a corresponding slot in which a last symbol of the corresponding slot is not empty and/or the like. For example, the SCI may include a field explicitly indicating that the corresponding transmission is a sensing transmission (e.g., a 1-bit field in SCI-1 or SCI-2). As another example, the SCI may include a field with a value set to an invalid value to indicate the corresponding transmission is a sensing transmission (e.g., setting an MCS field to an invalid MCS value). In addition, a preconfigured sequence of the sensing transmission may include, for example, at least one preconfigured sequence (e.g., unique and/or from a set of specific sequences). A preconfigured sequence may be defined over a set of symbols (e.g., in the frequency domain) and/or directly in the time domain. As a further example, if the last symbol of a transmission in a sidelink resource (e.g., a slot) is identified as not empty (e.g., a high energy symbol that satisfies a preconfigured threshold energy level), this may indicate a sensing transmission, as a gap symbol is used in data transmissions, and the high energy indicates a gap symbol not being present. While, in some situations, a gap symbol may be used in the last slot of a sensing transmission, the UE may identify, as part of the sensing transmission, the sidelink resources in a slot that follows a slot in which the last symbol is not a gap symbol.

In some aspects, any combination of the foregoing criteria for identifying a transmission as a sensing transmission may be used by the UE.

In some aspects, the UE may determine a third CBR associated with transmissions (e.g., all transmissions meeting certain criteria, which may include both data and sensing transmissions) detected over a third period of time that at least partially overlaps with the first period of time. In some aspects, the third CBR is based at least in part on a portion of sidelink resources, in a sidelink resource pool that were used for any transmissions that satisfy a third signal strength threshold (e.g., a preconfigured RSSI threshold for transmissions to be included in a CBR calculation). The UE may measure the third CBR in a manner similar to that of the first and second CBR described herein. For example, the third CBR may be measured at a slot n and defined as a portion of sidelink resources in the sidelink resource pool that were used for any transmissions (e.g., data/communication transmissions, sensing/radar transmissions, or other transmissions) over a CBR measurement window and that have an RSSI, measured by the UE, that satisfies a threshold (e.g., a preconfigured RSSI threshold). The CBR measurement window may be configured to be the same as or different from other CBR measurement windows described herein, and may be configured in a similar way as described herein.

By way of example, in a situation where the third period of time (e.g., the CBR measurement window) includes 1,000 sidelink resources, and 900 were used for transmissions with RSSI satisfying the third signal strength threshold, the UE may determine that the third CBR is 0.9 (e.g., 900/1,000=0.9). In this situation, given the aforementioned example values for the first CBR (e.g., 0.3) and the second CBR (e.g., 0.5), the UE may determine that some (e.g., 100) of the transmissions counted in the third CBR are neither data transmissions nor sensing transmissions. For example, this may occur when the third signal strength threshold is lower than the first signal strength threshold associated with the first CBR and lower than the second signal strength threshold associated with the second CBR.

In some aspects, the UE may identify a transmission as a joint data and sensing communication. For example, one transmission in a single sidelink resource may carry data and also be used as a probing signal to perform sensing at the same time. These joint data and sensing transmissions, because they carry data, may be detected as data transmissions. Accordingly, in some aspects, the joint data and sensing transmissions may only contribute to the first CBR for data transmissions.

While the first CBR, second CBR, and third CBR are referred to as “first,” “second,” and “third,” this should not be interpreted as limiting the order in which they are determined or used. Any of the three CBRs, including any combination of the CBRs, may be used for determining transmission parameters, as described further herein.

As shown by reference number 615, the UE may determine a CR threshold for a communication. The UE may use the CR threshold, for example, to determine transmission parameters for the communication in a manner designed to ensure the CR of the UE, which may reflect the congestion that the UE contributes to the network (e.g., the sidelink network), does not exceed the CR threshold.

In some aspects, the UE may determine CR for data communications separately from a CR for sensing communications and/or a CR for all communications. For example, a sidelink data CR evaluated at a slot n may be defined as the total number of sidelink resources used for the UE's data transmissions in slots n−a to n−1, granted for the UE's data transmissions in slots n to n+b, and divided by the total number of configured sidelink resources in the sidelink resource pool over n−a to n+b. A sidelink sensing CR evaluated at a slot n may be defined as the total number of sidelink resources used for the UE's sensing transmissions in slots n−a to n−1 and granted for the UE's sensing transmissions in slots n to n+b, divided by the total number of configured sidelink resources in the sidelink resource pool over n−a to n+b. An inclusive CR that includes all of the UE's transmissions may be determined in a similar manner.

By way of example, a UE may determine CR at slot n as follows: N_{r,1} sidelink resources used for sensing transmission in slots [n−a, n−1] and N_{r,2} sidelink resources granted for sensing transmission in slots [n, n+b], and N_{d,1} sidelink resources used for data transmission in slots [n−a, n−1] and N_{d,2} sidelink resources granted for data transmission in slots [n, n+b] may result in:

$$inclusive CR = \frac{{N}_{d , 1} + {N}_{d , 1} + {N}_{r , 1} + {N}_{r , 2}}{{N}_{t o t}} \qquad ( 1 )$$

$$data CR = \frac{{N}_{d , 1} + {N}_{d , 1}}{{N}_{t o t}} \qquad ( 2 )$$

$$sensing CR = \frac{{N}_{r , 1} + {N}_{r , 2}}{{N}_{t o t}} \qquad ( 3 )$$

Nₜₒₜ is the total number of subchannels contained in slots [n−a, n+b]. While at least some of the variables n, a, and b are used in the aforementioned formulas for calculation of one or more CBRs and/or CRs, the variables may be independent. For example, the variables may have different values (or the same values) for different CBR/CR calculations (e.g., the value of a used for the first CBR may be different from the value of a used for the data CR).

In some aspects, a communication to be transmitted by the UE may be a joint data and sensing communication. For example, one transmission in a single sidelink resource may carry data and also be used as a probing signal to perform sensing at the same time. In some aspects, joint data and sensing transmissions, because they carry data, may be considered data transmissions. Accordingly, in some aspects, the joint data and sensing transmissions may only contribute to the data CR. In some aspects, because they are used as probing signals, the joint data and sensing transmissions may be considered sensing transmissions and only contribute to the sensing CR. In some aspects, the joint data and sensing transmission may contribute to both data CR and sensing CR. For example, a first preconfigured portion of the sidelink resources (e.g., a preconfigured percent) for a joint data and sensing transmission may be counted for the data CR while a second preconfigured portion of the sidelink resources (e.g., another preconfigured percent) for the joint data and sensing transmission may be counted for the sensing CR. As an example, 60% of the joint data and sensing transmission may be treated as a data transmission counting toward the data CR, while the remaining 40% of the joint data and sensing transmission may be treated as a sensing transmission counting toward the sensing CR.

In some aspects, the UE may determine, based at least in part on the first CBR, a first CR threshold for the communication. For example, if the communication is a data transmission, the first CR threshold may be a CR threshold specifically for data transmissions. In some aspects, the UE may determine the first CR threshold based at least in part on a mapping of the first CBR to the first CR threshold. For example, for any given first CBR value, there may be a corresponding first CR threshold. In some aspects, the first CBR value may map to multiple thresholds (e.g., separate thresholds for different transmission priorities).

In some aspects, the UE may determine, based at least in part on the second CBR, a second CR threshold for the communication. For example, if the communication is a sensing transmission, the second CR threshold may be a CR threshold specifically for sensing transmissions. In some aspects, the UE may determine the second CR threshold based at least in part on a mapping of the second CBR to the second CR threshold. For example, for any given second CBR value, there may be a corresponding second CR threshold. In some aspects, the second CBR value may map to multiple thresholds (e.g., separate thresholds for different transmission priorities).

In some aspects, the UE may determine, based at least in part on the third CBR, a third CR threshold for the communication. For example, the third CR threshold may be a CR threshold that may be used for both data transmissions and sensing transmissions (e.g., an inclusive CR threshold). In some aspects, the UE may determine the third CR threshold based at least in part on a mapping of the third CBR to the third CR threshold. For example, for any given third CBR value, there may be a corresponding third CR threshold. In some aspects, the third CBR value may map to multiple thresholds (e.g., separate thresholds for different transmission priorities).

In some aspects, a CR threshold may be selected based on a one or more of the first CBR, the second CBR and/or the third CBR. For example, any combination of CBR values may map to one or more CR thresholds for different types and priorities of transmissions. For a given first CBR value, second CBR value, and third CBR value, for example, the UE may be preconfigured with a mapping that identifies, based at least in part on the CBR values, a set of CR thresholds. The set of CR thresholds may include, for example, a data CR threshold for data transmissions, a sensing CR threshold for sensing transmissions, an inclusive CR threshold for any type of transmission, and/or separate thresholds for different priority communications of any of the foregoing types. In this way, the UE may use the CR value of any type of transmission to compare to any mapped CR threshold (e.g., based on the CBR values) to determine transmission parameters, as described herein.

As shown by reference number 620, the UE may transmit a communication based at least in part on the first CBR and the second CBR. For example, the first CBR and second CBR may be used to determine a CR threshold. In some aspects, the CR threshold used for transmission may depend on the type of communication. For example, a data transmission may have a corresponding data CR threshold (e.g., the first threshold), and a sensing transmission may have a corresponding sensing CR threshold (e.g., the second threshold). As another example, an inclusive CR threshold may be used for any type of transmission (e.g., both data and sensing transmissions).

In some aspects, the UE may set and/or adjust one or more transmission parameters for the communication based at least in part on the first CBR, the second CBR, and/or the third CBR. For example, the first, second, and/or third CBR may be used to determine one or more CR thresholds. Using the CR threshold(s), the UE may determine which transmission parameters to use to ensure an upcoming transmission has a CR value that does not exceed the CR threshold(s). In some aspects, the transmission parameters may include an MCS, a number of subchannels, and/or a number of retransmissions to be used for transmitting the communication.

By way of example, before transmitting a data transmission, a UE may determine a data CBR, a sensing CBR and an inclusive CBR. The UE may map the three CBR values to a set of CR thresholds, which may include a data CR threshold for the data transmission. Using the data CR threshold, the UE may select an MCS value (among other parameters) for the data transmission that will ensure the data transmission does not exceed the data CR threshold. After selecting the MCS value, the UE may then transmit the data transmission.

In this way, the UE may use separate CR thresholds for the UE's data transmissions and sensing transmissions, which enables the UE to apply different congestion control between the different types of transmissions when performing congestion control (e.g., transmitting different types of communications with different parameters). In this way, the UE may facilitate the use of a sidelink resource pool in a manner that may improve, relative to congestion control that does not differentiate between transmission types, the UE's ability to reduce collisions and interference among transmissions while also separately prioritizing and managing QoS for data transmissions and/or sensing transmissions. For example, by using different CBR measurements, CR calculations, and/or CR thresholds, the UEs that use a sidelink resource pool may address collisions and interference by prioritizing data and/or sensing transmissions differently.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with sidelink congestion control for sensing and data transmissions.

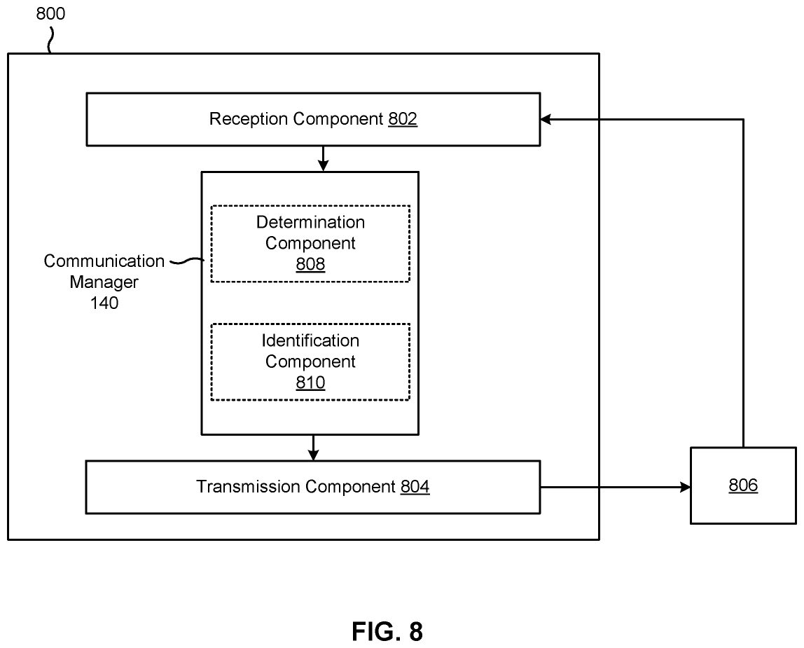

As shown in FIG. 7, in some aspects, process 700 may include determining a first CBR associated with one or more data transmissions detected over a first period of time (block 710). For example, the UE (e.g., using communication manager 140 and/or determination component 808, depicted in FIG. 8) may determine a first CBR associated with one or more data transmissions detected over a first period of time, as described above.

As further shown in FIG. 7, in some aspects, process 700 may include determining a second CBR associated with one or more sensing transmissions detected over a second period of time that at least partially overlaps with the first period of time (block 720). For example, the UE (e.g., using communication manager 140 and/or determination component 808, depicted in FIG. 8) may determine a second CBR associated with one or more sensing transmissions detected over a second period of time that at least partially overlaps with the first period of time, as described above.

As further shown in FIG. 7, in some aspects, process 700 may include transmitting a communication based at least in part on the first CBR and the second CBR (block 730). For example, the UE (e.g., using communication manager 140 and/or transmission component 804, depicted in FIG. 8) may transmit a communication based at least in part on the first CBR and the second CBR, as described above.

Process 700 may include additional aspects, such as any single aspect or any combination of aspects described below and/or in connection with one or more other processes described elsewhere herein.

In a first aspect, process 700 includes determining, based at least in part on the first CBR, a first CR threshold for the communication, the first CR threshold being associated with the one or more data transmissions, and wherein transmitting the communication comprises transmitting a data transmission based at least in part on the first CR threshold.

In a second aspect, alone or in combination with the first aspect, transmitting the data transmission further comprises selecting one or more values for one or more transmission parameters based at least in part on the first CR threshold, and transmitting the data transmission using the one or more values for the one or more transmission parameters.

In a third aspect, alone or in combination with one or more of the first and second aspects, process 700 includes determining, based at least in part on the second CBR, a second CR threshold for the communication, the second CR threshold being associated with the one or more sensing transmissions, and wherein transmitting the communication comprises transmitting a sensing transmission based at least in part on the second CR threshold.

In a fourth aspect, alone or in combination with one or more of the first through third aspects, transmitting the sensing transmission further comprises selecting one or more values for one or more transmission parameters based at least in part on the second CR threshold, and transmitting the sensing transmission using the one or more values for the one or more transmission parameters.

In a fifth aspect, alone or in combination with one or more of the first through fourth aspects, process 700 includes determining a third CBR associated with a plurality of transmissions detected over a third period of time that at least partially overlaps with the first period of time, and wherein the communication is transmitted further based at least in part on the third CBR.

In a sixth aspect, alone or in combination with one or more of the first through fifth aspects, process 700 includes determining, based at least in part on the third CBR, a third CR threshold for the communication, the third CR threshold being associated with both the one or more data transmissions and the one or more sensing transmissions, and wherein transmitting the communication comprises transmitting a data transmission based at least in part on the third CR threshold.

In a seventh aspect, alone or in combination with one or more of the first through sixth aspects, the first CBR is based at least in part on a portion of resources, in a sidelink resource pool, that were used for the one or more data transmissions, and a signal strength measurement that satisfies a first signal strength threshold.

In an eighth aspect, alone or in combination with one or more of the first through seventh aspects, the second CBR is based at least in part on a portion of resources, in a sidelink resource pool, that were used for the one or more sensing transmissions, and a signal strength measurement that satisfies a second signal strength threshold.

In a ninth aspect, alone or in combination with one or more of the first through eighth aspects, process 700 includes identifying each of the one or more sensing transmissions based at least in part on each of the one or more sensing transmissions satisfying a sensing CBR signal strength threshold, and each of the one or more sensing transmissions having one or more sensing-specific characteristics.

In a tenth aspect, alone or in combination with one or more of the first through ninth aspects, the sensing-specific characteristics include at least one of sidelink control information indicating a sensing transmission, the sensing transmission includes a preconfigured sequence identifying the sensing transmission, or the sensing transmission having a corresponding slot in which a last symbol of the corresponding slot is not empty.

In an eleventh aspect, alone or in combination with one or more of the first through tenth aspects, process 700 includes identifying each of the one or more data transmissions based at least in part on each of the one or more data transmissions satisfying a data CBR signal strength threshold, and each of the one or more data transmissions having one or more data-specific characteristics.

In a twelfth aspect, alone or in combination with one or more of the first through eleventh aspects, the data-specific characteristics include at least one of sidelink control information indicating a data transmission, or the data transmission having a corresponding slot in which a last symbol of the corresponding slot is empty.

In a thirteenth aspect, alone or in combination with one or more of the first through twelfth aspects, transmitting the communication comprises transmitting the communication using one or more transmission parameters that are based at least in part on the first CBR and the second CBR, wherein the one or more transmission parameters comprise at least one of a modulation and coding scheme, a number of subchannels, or a number of retransmissions.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a determination component 808 or an identification component 810, among other examples.

In some aspects, the apparatus 800 may be configured to perform one or more operations described herein in connection with FIGS. 3-6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The determination component 808 may determine a first CBR associated with one or more data transmissions detected over a first period of time. The determination component 808 may determine a second CBR associated with one or more sensing transmissions detected over a second period of time that at least partially overlaps with the first period of time. The transmission component 804 may transmit a communication based at least in part on the first CBR and the second CBR.

The determination component 808 may determine, based at least in part on the first CBR, a first CR threshold for the communication, the first CR threshold being associated with the one or more data transmissions.

The determination component 808 may determine, based at least in part on the second CBR, a second CR threshold for the communication, the second CR threshold being associated with the one or more sensing transmissions.

The determination component 808 may determine a third CBR associated with a plurality of transmissions detected over a third period of time that at least partially overlaps with the first period of time.

The determination component 808 may determine, based at least in part on the third CBR, a third CR threshold for the communication, the third CR threshold being associated with both the one or more data transmissions and the one or more sensing transmissions.

The identification component 810 may identify each of the one or more sensing transmissions based at least in part on each of the one or more sensing transmissions satisfying a sensing CBR signal strength threshold, and each of the one or more sensing transmissions having one or more sensing-specific characteristics.

The identification component 810 may identify each of the one or more data transmissions based at least in part on each of the one or more data transmissions satisfying a data CBR signal strength threshold, and each of the one or more data transmissions having one or more data-specific characteristics.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: determining a first CBR associated with one or more data transmissions detected over a first period of time; determining a second CBR associated with one or more sensing transmissions detected over a second period of time that at least partially overlaps with the first period of time; and transmitting a communication based at least in part on the first CBR and the second CBR.

Aspect 2: The method of Aspect 1, further comprising: determining, based at least in part on the first CBR, a first CR threshold for the communication, the first CR threshold being associated with the one or more data transmissions; and wherein transmitting the communication comprises: transmitting a data transmission based at least in part on the first CR threshold. wherein transmitting the communication comprises: transmitting a data transmission based at least in part on the first CR threshold.

Aspect 3: The method of Aspect 2, wherein transmitting the data transmission further comprises: selecting one or more values for one or more transmission parameters based at least in part on the first CR threshold; and transmitting the data transmission using the one or more values for the one or more transmission parameters.

Aspect 4: The method of any of Aspects 1-3, further comprising: determining, based at least in part on the second CBR, a second CR threshold for the communication, the second CR threshold being associated with the one or more sensing transmissions; and wherein transmitting the communication comprises: transmitting a sensing transmission based at least in part on the second CR threshold. wherein transmitting the communication comprises: transmitting a sensing transmission based at least in part on the second CR threshold.

Aspect 5: The method of Aspect 4, wherein transmitting the sensing transmission further comprises: selecting one or more values for one or more transmission parameters based at least in part on the second CR threshold; and transmitting the sensing transmission using the one or more values for the one or more transmission parameters.

Aspect 6: The method of any of Aspects 1-5, further comprising: determining a third CBR associated with a plurality of transmissions detected over a third period of time that at least partially overlaps with the first period of time; and wherein the communication is transmitted further based at least in part on the third CBR. wherein the communication is transmitted further based at least in part on the third CBR.

Aspect 7: The method of Aspect 6, further comprising: determining, based at least in part on the third CBR, a third CR threshold for the communication, the third CR threshold being associated with both the one or more data transmissions and the one or more sensing transmissions; and wherein transmitting the communication comprises: transmitting a data transmission based at least in part on the third CR threshold. wherein transmitting the communication comprises: transmitting a data transmission based at least in part on the third CR threshold.

Aspect 8: The method of any of Aspects 1-7, wherein the first CBR is based at least in part on: a portion of resources, in a sidelink resource pool, that were used for the one or more data transmissions, and a signal strength measurement that satisfies a first signal strength threshold.

Aspect 9: The method of any of Aspects 1-8, wherein the second CBR is based at least in part on: a portion of resources, in a sidelink resource pool, that were used for the one or more sensing transmissions, and a signal strength measurement that satisfies a second signal strength threshold.

Aspect 10: The method of any of Aspects 1-9, further comprising: identifying each of the one or more sensing transmissions based at least in part on: each of the one or more sensing transmissions satisfying a sensing CBR signal strength threshold, and each of the one or more sensing transmissions having one or more sensing-specific characteristics.

Aspect 11: The method of Aspect 10, wherein the sensing-specific characteristics include at least one of: sidelink control information indicating a sensing transmission, the sensing transmission includes a preconfigured sequence identifying the sensing transmission, or the sensing transmission having a corresponding slot in which a last symbol of the corresponding slot is not empty.

Aspect 12: The method of any of Aspects 1-11, further comprising: identifying each of the one or more data transmissions based at least in part on: each of the one or more data transmissions satisfying a data CBR signal strength threshold, and each of the one or more data transmissions having one or more data-specific characteristics.

Aspect 13: The method of Aspect 12, wherein the data-specific characteristics include at least one of: sidelink control information indicating a data transmission, or the data transmission having a corresponding slot in which a last symbol of the corresponding slot is empty.

Aspect 14: The method of any of Aspects 1-13, wherein transmitting the communication comprises: transmitting the communication using one or more transmission parameters that are based at least in part on the first CBR and the second CBR, wherein the one or more transmission parameters comprise at least one of: a modulation and coding scheme, a number of subchannels, or a number of retransmissions.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
determine a first channel busy ratio (CBR) associated with one or more data transmissions detected over a first period of time;
determine a second CBR associated with one or more sensing transmissions detected over a second period of time that at least partially overlaps with the first period of time; and
transmit a communication based at least in part on the first CBR and the second CBR.

2. The UE of claim 1, wherein the one or more processors are further configured to:
determine, based at least in part on the first CBR, a first channel occupancy ratio (CR) threshold for the communication, the first CR threshold being associated with the one or more data transmissions; and
wherein the one or more processors, to transmit the communication, are configured to:
transmit a data transmission based at least in part on the first CR threshold.

3. The UE of claim 2, wherein the one or more processors, to transmit the data transmission, are configured to:
select one or more values for one or more transmission parameters based at least in part on the first CR threshold; and
transmit the data transmission using the one or more values for the one or more transmission parameters.

4. The UE of claim 1, wherein the one or more processors are further configured to:
determine, based at least in part on the second CBR, a second channel occupancy ratio (CR) threshold for the communication, the second CR threshold being associated with the one or more sensing transmissions; and
wherein the one or more processors, to transmit the communication, are configured to:
transmit a sensing transmission based at least in part on the second CR threshold.

5. The UE of claim 4, wherein the one or more processors, to transmit the sensing transmission, are configured to:
select one or more values for one or more transmission parameters based at least in part on the second CR threshold; and
transmit the sensing transmission using the one or more values for the one or more transmission parameters.

6. The UE of claim 1, wherein the one or more processors are further configured to:
determine a third CBR associated with a plurality of transmissions detected over a third period of time that at least partially overlaps with the first period of time; and
wherein the communication is transmitted further based at least in part on the third CBR.

7. The UE of claim 6, wherein the one or more processors are further configured to:
determine, based at least in part on the third CBR, a third channel occupancy ratio (CR) threshold for the communication, the third CR threshold being associated with both the one or more data transmissions and the one or more sensing transmissions; and
wherein the one or more processors, to transmit the communication, are configured to:
transmit a data transmission based at least in part on the third CR threshold.

8. The UE of claim 1, wherein the first CBR is based at least in part on:
a portion of resources, in a sidelink resource pool, that were used for the one or more data transmissions, and
a signal strength measurement that satisfies a first signal strength threshold.

9. The UE of claim 1, wherein the second CBR is based at least in part on:
a portion of resources, in a sidelink resource pool, that were used for the one or more sensing transmissions, and
a signal strength measurement that satisfies a second signal strength threshold.

10. The UE of claim 1, wherein the one or more processors are further configured to:
identify each of the one or more sensing transmissions based at least in part on:
each of the one or more sensing transmissions satisfying a sensing CBR signal strength threshold, and
each of the one or more sensing transmissions having one or more sensing-specific characteristics.

11. The UE of claim 10, wherein the sensing-specific characteristics include at least one of:
sidelink control information indicating a sensing transmission,
the sensing transmission includes a preconfigured sequence identifying the sensing transmission, or
the sensing transmission having a corresponding slot in which a last symbol of the corresponding slot is not empty.

12. The UE of claim 1, wherein the one or more processors are further configured to:
identify each of the one or more data transmissions based at least in part on:
each of the one or more data transmissions satisfying a data CBR signal strength threshold, and
each of the one or more data transmissions having one or more data-specific characteristics.

13. The UE of claim 12, wherein the data-specific characteristics include at least one of:
sidelink control information indicating a data transmission, or
the data transmission having a corresponding slot in which a last symbol of the corresponding slot is empty.

14. The UE of claim 1, wherein the one or more processors, to transmit the communication, are configured to:
transmit the communication using one or more transmission parameters that are based at least in part on the first CBR and the second CBR, wherein the one or more transmission parameters comprise at least one of:
a modulation and coding scheme,
a number of subchannels, or
a number of retransmissions.

15. A method of wireless communication performed by a user equipment (UE), comprising:
determining a first channel busy ratio (CBR) associated with one or more data transmissions detected over a first period of time;
determining a second CBR associated with one or more sensing transmissions detected over a second period of time that at least partially overlaps with the first period of time; and
transmitting a communication based at least in part on the first CBR and the second CBR.

16. The method of claim 15, further comprising:
determining, based at least in part on the first CBR, a first channel occupancy ratio (CR) threshold for the communication, the first CR threshold being associated with the one or more data transmissions; and
wherein transmitting the communication comprises:
transmitting a data transmission based at least in part on the first CR threshold.

17. The method of claim 16, wherein transmitting the data transmission further comprises:
selecting one or more values for one or more transmission parameters based at least in part on the first CR threshold; and
transmitting the data transmission using the one or more values for the one or more transmission parameters.

18. The method of claim 15, further comprising:
determining, based at least in part on the second CBR, a second channel occupancy ratio (CR) threshold for the communication, the second CR threshold being associated with the one or more sensing transmissions; and
wherein transmitting the communication comprises:
transmitting a sensing transmission based at least in part on the second CR threshold.

19. The method of claim 18, wherein transmitting the sensing transmission further comprises:
selecting one or more values for one or more transmission parameters based at least in part on the second CR threshold; and
transmitting the sensing transmission using the one or more values for the one or more transmission parameters.

20.-28. (canceled)

29. A non-transitory computer-readable medium storing a set of instructions for wireless communication, the set of instructions comprising:
one or more instructions that, when executed by one or more processors of a user equipment (UE), cause the UE to:
determine a first channel busy ratio (CBR) associated with one or more data transmissions detected over a first period of time;
determine a second CBR associated with one or more sensing transmissions detected over a second period of time that at least partially overlaps with the first period of time; and
transmit a communication based at least in part on the first CBR and the second CBR.

30. (canceled)
